(19) United States
(12) Patent Application Publication
(10) Pub. No.: US 2016/0358283 A1
(43) Pub. Date: Dec. 8, 2016

(54) ONLINE SOCIAL GAME FOR PROMOTING CHALLENGE-BASED ACTIVITY

(71) Applicant: Shane Regala, Louisville, KY (US)

(72) Inventor: Shane Regala, Louisville, KY (US)

(73) Assignee: HUMANA INC., Louisville, KY (US)

(21) Appl. No.: 13/098,848

(22) Filed: May 2, 2011

(51) Int. Cl. A63F 9/24

(52) U.S. Cl. CPC G06Q 50/22

(57) ABSTRACT

An online game that provides a virtual village where users can communicate with one another, report information about themselves, and keep track of activities in the real world. Each user has an avatar that can be viewed by other users, and the avatars provide visual representations about the activities of their user. Users can participate in challenges with one another based on different activities, and activity data is either self-reported or reported by a variety of biometric devices. Activity data can provide a real-time visual representation of the activities of the users. Completion of activities and challenges earn users virtual points that may be used to obtain virtual rewards or real-life rewards. Calendars and other tools allow users to apprise others on their upcoming activities, as well as seek help or encouragement from others. Messaging capabilities allow users to share ideas and information through a variety of media.

### FIELD OF THE INVENTION

The present invention relates to computerized games that encourage social interaction and healthy habits among users. In particular, the present invention relates to an online community through which users can share challenges and goals related to different activities, as well as provide support and encouragement for one another.

### BACKGROUND OF THE INVENTION

People today are busier than ever. Between, work, family, school, activities, chores, and errands, many people are busy doing one thing or another from morning to night. While being busy can have its positive qualities, it also makes certain aspects of life more difficult. It is difficult for a person to achieve their health and exercise goals when they are low on time and have other obligations that may seem more important or pressing. Being busy can also cause families and friends to communicate less with each other, since they have less time available to call one another or meet each other in person. As a result, family and friends may lose touch of what is going on in each other's lives, and may miss out on the goals and ambitions of one another, as well as miss out on the activities other people are involved in. Similarly, some people may not realize that they share common interests or goals with one another, or that they participate in the same activities, whether they are fitness-related or otherwise. A busy schedule may also make it difficult for people to remember the tasks and errands that need to be done on a day to day basis. This can be something as small as taking medication or as big as hiring a baby sitter to watch the kids on an upcoming weekend. Overall, the busy lives people lead can make people feel removed and out of touch from family and the community they live in, since they may lack time to be face-to-face with family, socialize with friends, or meet new people and explore and share in interests with one another. It may also prevent people from having the necessary support from others to achieve their goals, and the motivation that often comes as a result of being in friendly competition with other people.

Therefore, there is a need for a game that can allow people to connect, interact, and socialize with one another in a virtual community atmosphere. There is also a need for a game that allows users to check on the activities that other users have currently or recently engaged in. There is also a need for a game that allows players to check on their schedules and sign up for events, activities, and challenges with other players. There is also a need for a game that allows users to identify their goals and show their progress towards those goals to others, as well as a game that allows different users to compete towards the same goal. There is also a need for a game that is on-line so that it can be accessed from multiple computers, and therefore more convenient for a user to play the game. There is also a need for a game that makes it easy for users to upload their activity data into the system. There is also a need for a fun and entertaining way of visually representing users and their activity levels in the game, and a way for users to customize their game experience.

### SUMMARY OF THE INVENTION

The present invention is an online game that provides users with the ability to connect, socialize, and engage in activities with one another. Users can establish challenges that involve one or more activities, and can invite other users to participate in the challenges with them. The completion of activities and challenges may result in points being awarded to users, and points may be used to purchase virtual rewards or real-life rewards. Information about a user's activities may come from either self-reported data or device data. Many different biometric devices, such as pedometers, may be used in association with the game. Through user avatars, the game may provide visual representations of the activities users are engaged in, their current location in the real-world, or their achievements. The game may provide a real-time view on what its users are doing in the real-world. Users can communicate and share information with one another in a variety of ways. They can post messages to one another, send invitations to other users about events, post questions, share media such as music, photos, or web links, and can even share their calendars with one another. User avatars may also have backpacks that contain items of interest that can be viewed by other players. The game may be customized by the user in many different ways. Users can create their own villages, activities, challenges, and even rewards. Also, users can control permissions on their game account in order to maintain privacy if desired.

### BRIEF DESCRIPTION OF THE DRAWINGS

FIG. 1 is a village view of a sample virtual village according to an example embodiment;

FIG. 2 is an illustration of a gym in a virtual village according to an example embodiment.

FIG. 3 is an illustration of the contents of a user's bag in an example embodiment.

FIG. 4 is a sample user home page according to an example embodiment;

FIG. 5 is a sample accounts page according to an example embodiment;

FIG. 6 is a sample permissions page according to an example embodiment;

FIG. 7 is a sample village map page according to an example embodiment;

FIG. 8 is a sample village page according to an example embodiment;

FIG. 9 is a sample add village page according to an example embodiment;

FIG. 10 is a sample invite page according to an example embodiment;

FIG. 11 is a sample profile page according to an example embodiment;

FIG. 12 is a sample challenges page according to an example embodiment;

FIG. 13 is a sample create challenge page according to an example embodiment;

FIG. 14 is a sample edit challenge page according to an example embodiment;

FIG. 15 is a create activity page according to an example embodiment;

FIG. 16 is a edit activity page according to an example embodiment;

FIG. 17 is a sample points application page according to an example embodiment;

FIG. 18 is a sample rewards page according to an example embodiment;

FIG. 19 is a sample gift page according to an example embodiment;

FIG. 20 is a sample buy rewards page according to an example embodiment;

FIG. 21 is a sample calendar page according to an example embodiment;

FIG. 22 is a sample add calendar item page according to an example embodiment;

FIG. 23 is a system and logic diagram of an example embodiment;

FIG. 24 is a system and logic diagram of an example embodiment,

FIG. 25 is a system diagram of an example embodiment;

FIG. 26 is an entity relationship diagram for an example embodiment.

### DETAILED DESCRIPTION

In one exemplary embodiment an on-line game provides a virtual community, or “village,” where users can communicate and interact with one another in a variety of ways, as well as check on the status and activities of other users. In this virtual village users can report information about themselves, which may include physical activity information, daily tasks information, and professional/business information. Activity information may come from self-reported data entered by the user or data that comes from input devices such as pedometers. Users can also focus on achieving a variety of beneficial goals and challenges such as eating right, taking on intellectual challenges, getting active, and staying socially engaged. Visual feedback is given about the real-world progress and activities of users, which are visually represented in the village by avatars. Scheduling and communication tools aid users in achieving their goals and keeping track of tasks. Progress towards goals and achievement of goals may earn points for a user that can eventually be spent on either virtual or real world rewards. Examples of real world rewards include discounts on athletic equipment, spa gift certificates, and gift cards for downloading music or videos.

In some embodiments points may be awarded to users for contact with the virtual village, which may include the reporting of physical activity, the achievement of goals, or just for logging into the community or posting a message to another user. Points may be used to allow a user to access different areas of the community, or otherwise alter the user's experience. The following are a few examples of ways in which a user may be awarded points: logging in, taking the stairs at work, performing household chores, babysitting for a friend, packing a healthy lunch, posting communication that a user took their medication, notifying other users that a user needs help or is in trouble, assisting another user that needs help or is in trouble, grocery shopping for healthy food, throwing a football with a child, organizing an event for the community, participating in an event, walking the dog, posting communication that a user took their vitamins, taking time for meditation or prayer, creating a budget, balancing a check book, calling a relative, having a picnic at a beach, going for a hike, getting a chiropractic adjustment or massage, encouraging other users in the community, putting a pedometer in a shoe and logging in miles, or drinking water. These are only a few examples, and there are many other ways in which users may earn points.

Points may be accumulated as desired and used by a user to earn virtual or real-life rewards. Virtual rewards may include trophies that are received after a measurable challenge has been won. Virtual communication rewards may allow a user to send special notes of encouragement or virtual cards to other users. An example is a child using points to send a virtual card to his or her mother. For some users, points may be used to send humorous challenge messages to other users. Virtual rewards may also include the ability to change the user experience in a desirable way, such as decorating or upgrading the village, obtaining access to new parts of the village, upgrades to the user's avatar, or even giving the user's avatar a bag or backpack. In some embodiments the reward may include the ability of the user to achieve heightened status in the village for a period of time, such as becoming queen for a day. Media rewards may include access to music, pictures, or videos. Real world rewards may include receiving products or discounts on products, such as clothes, toys, athletic equipment, electronics, spa visits, or vacations. In some embodiments, the user has the ability to customize their rewards to their personal taste. For examples, users in a family may enter as rewards a trip to go fishing with a certain family member, or the help of a family member to plant a flower garden or perform another chore. Users may also use their points to purchase gifts for other users. For example, users may have the ability to create their own virtual reward ribbons to award to other users to celebrate accomplishments.

The game may provide different visual views for the user, which can be considered as a village view, a location view, and a backpack view. In the village view, the user is given a real-time visual representation of what they are currently doing and where they are located in the village, as well as where other users in the village are and their activities as well. This view may be accomplished by a single glance by a user, because all users that are part of a village may be shown on the village map. Users are shown either moving toward a location in the village, or at the specific location that reflects their most recent activity. Activity information may be instantly updated based on user input or data from input devices such as pedometers and other biometric devices. Animation of the avatars may aid in showing the activity in which the associated users are engaged. For example, if a user is jogging, then their avatar may be shown jogging as well. Paths throughout a village may reveal timelines of past and present activities and challenges along that paths category (such as social, mental, diet, or physical challenges). The paths may allow players to check their own progress and the progress of others. The game may also allow users to zoom in on a particular avatar or activity and provide the user with a location view. The location view may be a two-dimensional front view that provides details about each player's status and activity. For example, the location view may show that a particular avatar belongs to Joe, he is at the gym, he arrived at 4:00 pm, and he plans to leave at 5:30 p.m. Message bubbles above avatars may show who the associated user is and provide a picture. In some embodiments the message bubbles may illustrate a particular user's current goals or their current emotional state. In other embodiments other information may be obtained from the location view. Another view that may exist is the backpack view. Each user may have a virtual backpack or “bag” that contains important items belonging to the user such as tools and trophies. Bags can be viewed by other users, and may be viewed by others in order to learn more about one another. Tools in a bag may include a scheduler and a communicator, which can be used together to make connections between persons using the game. The scheduler may be a shared calendar that allows users to share their plans and their needs with one another. Through the scheduler users can add one-time or repeating activities, open periods that they would like to fill with meaningful activity, or needs for help. For example, if a user wants to have a jogging partner, they can add their daily jog to the scheduler and allow their friends to see it in the hopes that someone else will offer to join them. Another example is a mother who wants to find a babysitter. She can add a one-time babysitting need to the scheduler and other users can view her entry and respond. Another example is a user who has a free afternoon every Wednesday and is looking for an activity. The user can add this to their scheduler and indicate that they are open to suggestions. Other users seeing these needs can respond. The communicator is a messaging system within the game that facilitates communication between different users through different media, and may also connect with outside social networking sites. The communicator can be used to remind users about upcoming events and challenges, forward notifications about user activities, and offer encouragement to other users. The communicator can also be used to forward entries made in the scheduler. An example of how the communicator may be used is that users can share missions, tips, and recipes with one another and receive points when others find their submissions helpful. These messages may be sent and accessed by users as they play the game, and some embodiments may also have the option of sending a message to a user's email account. Messages may be sent to a single user or can be sent to multiple users at once, depending on the sender's preferences.

In some embodiments the game may be personalized to each particular user. When a user first logs into the game, they may be asked questions about their goals, favorite activities, time constraints, and the kind of rewards that they personally find motivating. Family and other users enter the same information, and the game can use this information to create a personalized group profile and a customized village. For example, a family that begins to play the game may be grouped together into their own village. In some embodiments the users can create their own customized villages as desired. In some embodiments the game allows further enhancement by the user so that the gaming experience is as personalized as possible. For example, the user may be able to mimic a village after a real-world location, or may be able to customize the visuals of the game as desired.

There are many ways in which users can interact with one another and socialize through the game. Below are examples of how the game may be used:

### EXAMPLE 1

### The Jones Family's Use of the Game Throughout a Day

Morning
Mom logs into the game. She checks her family's progress in the challenges it is currently signed up for. She sees that the family is doing well with their Exercise challenge, but they need some improvement in their Healthy Eating challenge. Mom decides to make a healthy dinner tonight, but she isn't sure what to make. She checks the community recipe area where other users post recipes and finds a great recipe. She gives the recipe a “thumbs up” rating, which earns points for the user who submitted it.
Dad goes for a walk, wearing his pedometer. The distance he walks is transmitted to the game. The village map shows that Dad is talking a walk. His walk accrues points for the family Exercise challenge.
Daughter Sally's one week spring break starts today. She wants to do some additional healthy activities while she has time off. Sally updates her profile with her desire for a one week challenge and her newfound interest in roller skating. She creates a new individual goal to roller skate daily for the week.

Afternoon:
Son Bobby sits down and begins making progress on his Do Homework challenge. As he enters this information into the game it is reflected on the village map. Grandma, who lives in another state, logs into the game. From the village map, she can see that Bobby is doing his homework. Proud of his progress, Grandma sends Bobby an encouraging note. She earns points for communicating with Bobby.
Mom wants to spend some time at the store shopping for healthy ingredients, but she needs somebody to watch the kids. She adds her one-time babysitting need to her calendar. One of her friends sees the posting and offers to trade childcare days with Mom.
All of the members of the village receive a challenge message. The members of the Smith family village have invited them to a Chore challenge. The group that completes the most household chores in two weeks wins a reward. The Jones family accepts the challenge.

Evening:
Sally would like to learn more about her brother Bobby. She logs into the game and looks inside Bobby's virtual backpack. Bobby's backpack contains an image of a snowboard. Sally learns for the first time that Bobby is interested in snowboarding.
Grandma takes her blood pressure pills. She enters the information into the game and it is reflected on the village map. Grandma earns points for healthy living.
Dad logs into the game to check on Grandma. He is happy to see that she has taken her pills.
Mom makes a healthy dinner using the recipe that she received. She enters this information into the game and the whole family now gets points toward their Healthy Eating challenge.
The Healthy Eating challenge is completed, and the family now receives their pre-arranged reward, which is a real-world discount on a fishing rod from one of the game's corporate sponsors. To commemorate the reward, fish in the village's lake begin to animate. Excited about this reward and the prospect of taking a fishing trip, Dad uses the communication tool to announce the good news on another social networking site.

### EXAMPLE 2

### Use of the Game in an Office Setting

Mom receives an on-line invitation to join her office's village. She accepts the invitation.
Mom and her co-workers are invited to join a month-long, company-wide walking challenge. Their company is furnishing a special, custom reward for whoever walks the farthest: two extra days of paid vacation.
Over the weekend, Mom logs into her office village to check on the competition. The village view shows that several of her office mates are walking right now. Mom doesn't want her office mates to win over her, so she is inspired to take a walk herself.
Mom earns reward points for making progress towards her goal. She uses the points to buy some beautiful virtual flowers to put in her backpack.
Mom's backpack is accessible to her in all of her villages. While mom and her daughter Sally are looking at their family village, Mom shows Sally the flowers she earned.

### EXAMPLE 3

### Use of the Game Among Friends

Dad decides to set up a village for his biking club. He invites his biking friends to join the village.
Dad would like a biking buddy. He adds his preferred biking times to the group's shared calendar. A friend sees Dad's biking schedule and offers to join him.
Dad looks at another biking group's village. He sees that it is big and beautiful, which tells Dad that this other group is doing more biking than Dad's biking group. Dad needs some encouragement and sends a “help!” flare.
A friend see's Dad's flare. He knows that Dad is working hard and wants to encourage him. The friend spends some of his reward points on a special message for Dad.

### EXAMPLE 4

### Village View of a Family

A father and son are at home, not doing any specific activity. In the village view they are shown standing outside their house.
They decide to throw a football together. Data from the “smart football” is instantly transmitted to the virtual village. Now the father and son are shown standing together at the house, with a football image spinning between them.
If they have already reached a goal in this area, the image might be a golden football, showing everyone their current level of achievement.
Meanwhile, mom is heading to the gym for her daily 5:00 PM workout. This information was already entered via the scheduler, so mom doesn't need to enter any new information at this time.
As mom travels to the gym, in the village she is shown on a linear, colored path stretching from the house to the gym; she is shown standing at the gym once she arrives there.
The daughter makes a snap decision to go to the library. The moment she enters this information into the game, she is shown on her path to the library.

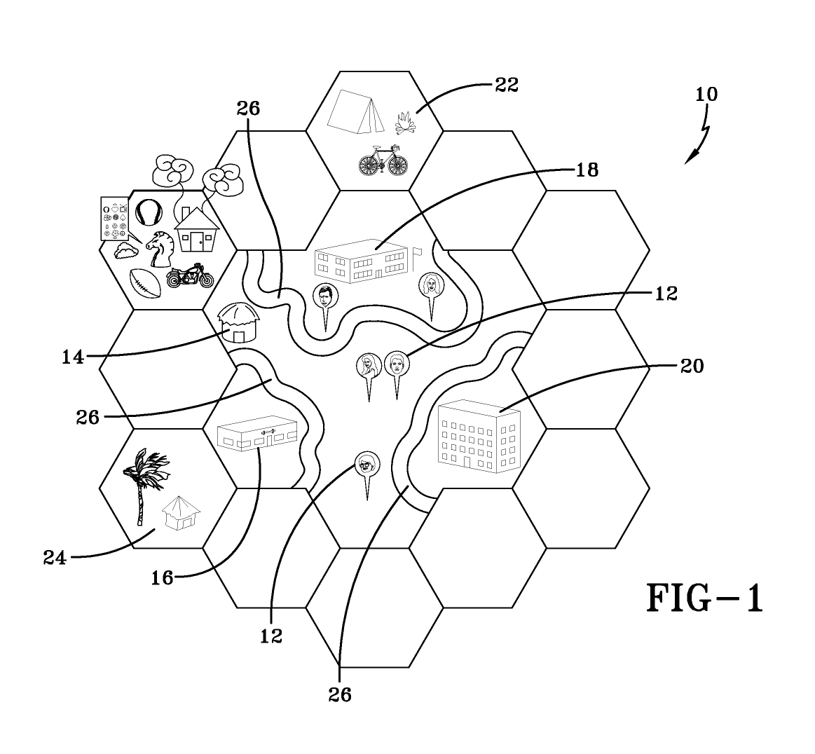

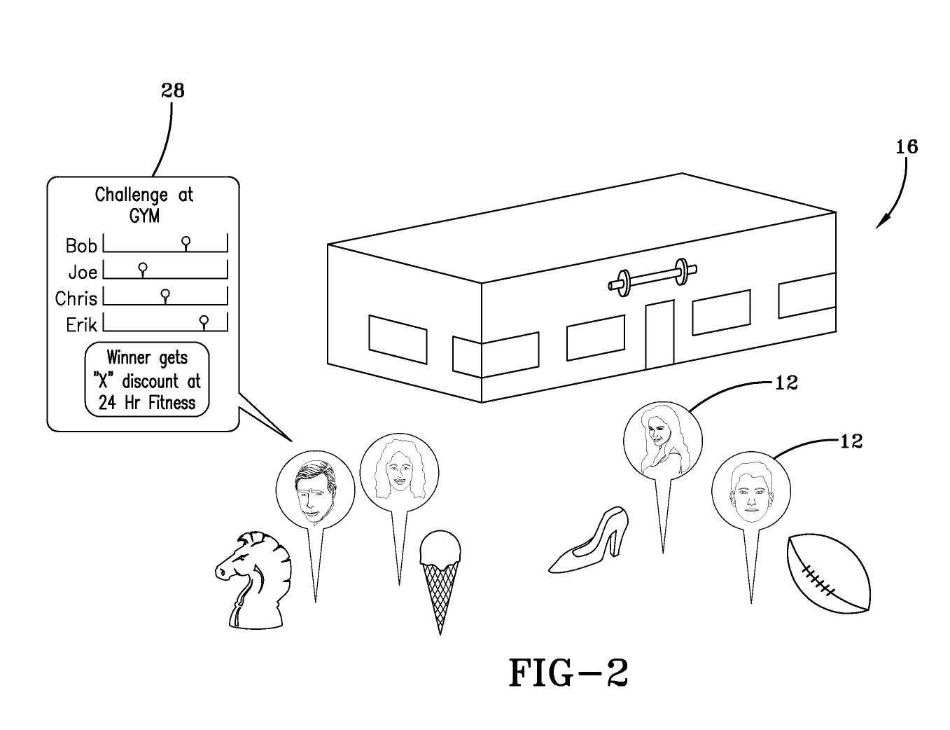

Referring to FIG. 1, a village view of a sample virtual village 10 of an example embodiment is shown. In this embodiment, different users of the game are represented in the village 10 by avatars 12 that bear images of the users. The village 10 may include visual representations of businesses, buildings, and other locations in the real world, such as a spa 14, a gym 16, a school 18, or an office building 20. The village 10 may have specific applications for users that are activity-specific. For example, an application for camping 22 or a vacation application 24. Depending on the embodiment, all users may be able to access these applications or the applications may be limited to particular users.

In response to information the game receives about a user, the avatar 12 for that user may change its location in the village. For example, if the game receives information that a particular user is at their workplace office, then the avatar 12 for that user may be located near the virtual office building 20 in the virtual village 10. If the game then receives information that the user is on their way to the gym 16, then the avatar 12 for that user may be shown moving along a path 26 in the village 10 from the office building 20 to the gym 16. Once the game receives information that the user is at the gym, the avatar 12 for that user is located at the virtual gym 16. Depending on information received by the game, avatars 12 may move throughout the village 10 to represent the movement of their respective users in the real world. Similarly, as users participate in activities or events in the real world, and that information is received by the game, their avatars may change location in the village 10 or their appearance may change to represent the activity. In this way the village 10 may provide a real-time representation of what its users are doing in the real world.

Referring to FIG. 2, an illustration of a gym 16 in a virtual village 10 of an example embodiment is shown. Different avatars 12 are located at the gym 16. A message bubble 28 communicates information to the users of the game that are viewing the gym 16 location. A message bubble 28 in FIG. 2 shows that there is a challenge at the gym, which has been entered into by four different users, Bob, Joe, Chris, and Erik, and that the prize for this particular challenge is a discount at the gym 16. This message bubble 28 also shows the relative progress of the users in this particular challenge.

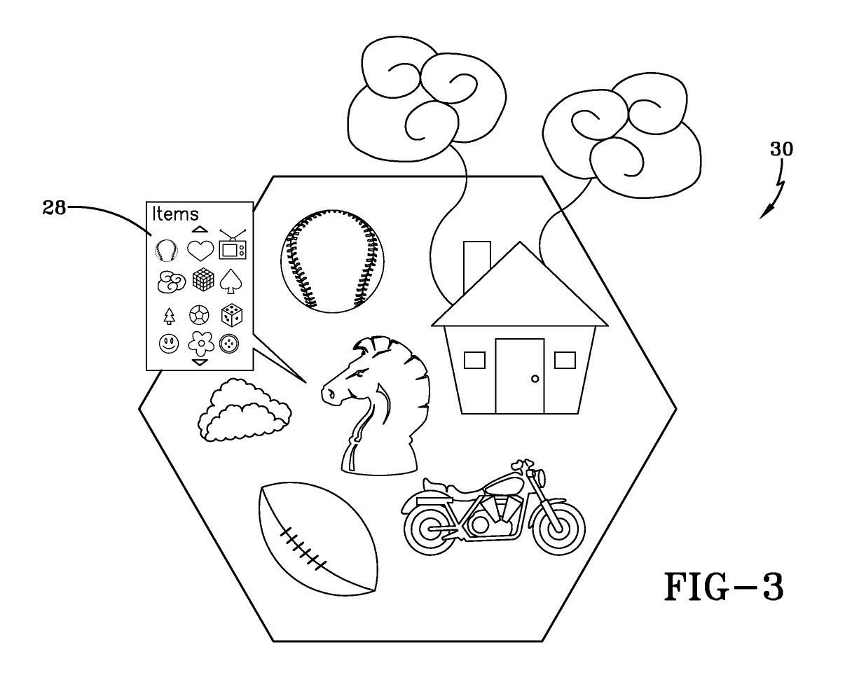

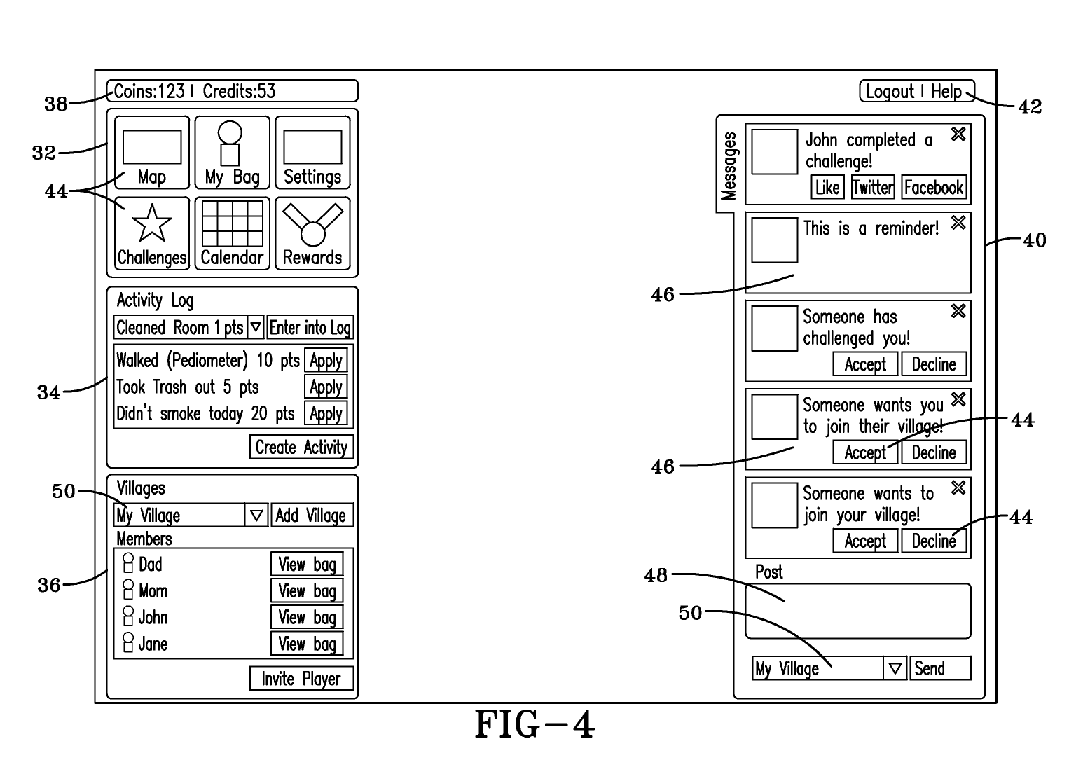

Referring to FIG. 3, an illustration of the contents of a user's bag 30 in an example embodiment is shown. The different items shown are those that the user has accumulated by playing the game, and may be the result of rewards earned or gifts received from other users. In this illustration, a message bubble 28 shows users the different items that are available to add to the user's bag 30.

Referring to FIG. 4, a sample user home page for an exemplary embodiment of the game is shown. This page may be viewable to a user once they have logged into the game, which may require use of a user name and password. As shown in FIG. 4, in this embodiment different panels are located on the left hand side of the page. In this embodiment the panels include a main control panel 32, an activity log panel 34, a villages panel 36, and a points bar 38. On the right hand side of the page is a messages tab 40. Also located on this user page is a log out/help button 42 for logging out of a user's account and for seeking help.

The main control panel 32 provides the user with access to many of the main features of the game. Buttons 44 on this panel allow the user to access the main features of the game, including a village map, the user's bag, challenge information, the user's calendar, rewards information, and game settings. The buttons 44 in this embodiment have text on them as well as icons representing what the buttons 44 access, but in other embodiments they may have no text or may only have text. Also, in other embodiments different buttons 44 may be available in the main control panel 32 to allow the user to access different attributes of the game.

The activity log panel 34 allows the user to see the point values associated with certain activities, enter information about their activities, and review past activity information. As an example, the activity log panel 34 in FIG. 4 tells the user that for not smoking the user may earn 20 points. The selection of buttons 44 on the activity log panel 34 allows the user to apply the activity of not smoking and receive the 20 points. Buttons on the activity log panel 34 also allow the user to create activities and edit activities. In some embodiments activity information may be received by a pedometer or other biometric device that is associated with the game system.

The villages panel 36 allows the user to manage the different villages they may be a member of, create new villages, and invite other users to become members of a particular village. In the embodiment shown in FIG. 4, the villages panel 36 displays the different members in a village, and buttons 44 allow the user to view the bag of each member in a village. In different embodiments the villages panel 36 may allow the user to perform other actions.

The points bar 38 displays for the user the amount of points that they have earned, which may be shown in terms of coins and credits. In FIG. 4, the user has accumulated 123 coins, and has 53 credits. In different embodiments the points bar 38 may display additional information, such as the ways in which a user obtained the points, or if points expire after a certain date. Also, in different embodiments points may be represented in different ways than coins and credits.

The messages tab 40 allows the user to view messages 46 received from other users and messages 46 generated by the system such as reminders about upcoming events. In some embodiments the messages 46 may contain pictures of the persons sending the messages 46, or other pictures related to the type of message. In some embodiments users may send message that include links to websites or other on-line social media. Depending on the type of message, the user may have buttons 44 available to take further action. For example, if a message 46 is asking a user to join a challenge, the message 46 may contain buttons 44 for accepting or declining the challenge. If the message 46 is about a challenge that another user has just completed, the message 46 may have a “like” button 44 that allows the user to make a public showing that they like the message 46. Other buttons may allow the user to post the message to other social networking sites. As shown in FIG. 4, in some embodiments the messages tab 40 will include a text box 48 that allows a user to enter or “post” their own message that they want to share with other users. The messages tab 40 may also include a scroll-down menu 50 that allows the user to select which village the message 46 is sent to and a button 44 for sending the message 46 to all users of the selected village once the message 46 is ready. In different embodiments a user may be able to do different things with messages

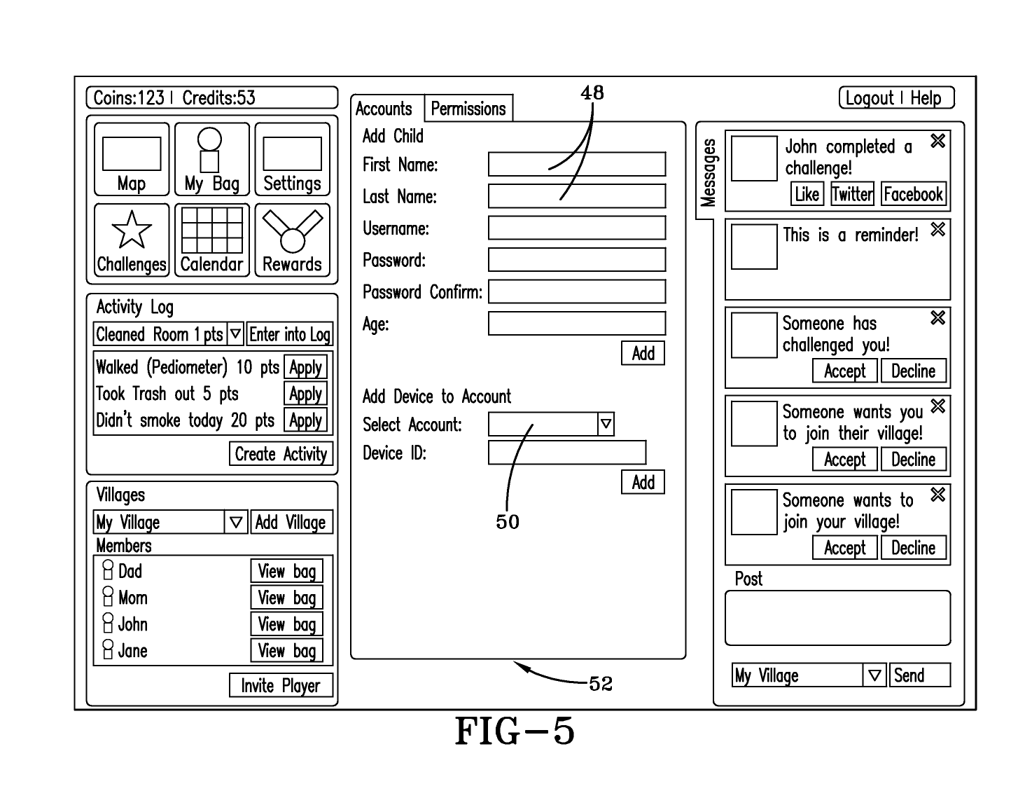

Referring to FIG. 5, a sample accounts page according to an example embodiment is shown. As in FIG. 4, this page includes a main control panel 32, activity log panel 34, villages panel 36, points bar 38, messages tab 40 and a log out and help button 42. In the center of this page is an accounts tab 52 that allows a user to change basic information about their account. The accounts tab 52 may be activated by selecting one of the buttons on the main control panel 32. In the embodiment shown in FIG. 5, the accounts tab 52 allows a user to add a child to their account by entering various pieces of information into text boxes 48. Requested information about the child includes their name, username, password, and age, and in other embodiments different information may be necessary. The accounts tab 52 also allows the user to add a device to their account. A scroll down menu 50 allows the user to select which account the device is to be associated with, and a text box allows the user to enter the device ID. A device may be anything that can report information about a user's activities to the game system. One example of a device is a pedometer that can report information to the game system about the amount of steps a user has taken. Another device is a smart football. In other embodiments different types of biometric devices may be used to report activity information to the game system. In some embodiments the device may be a cell phone or other personal electronic that has GPS capabilities and can report the user's location during particular activities. It may be possible for a user to have several devices associated with an account so that the game can recognize the different activities that the user engages in with the real world and use the information it receives from the devices to update the activity log, update challenge information, and otherwise represent the user's activities to other users of the game.

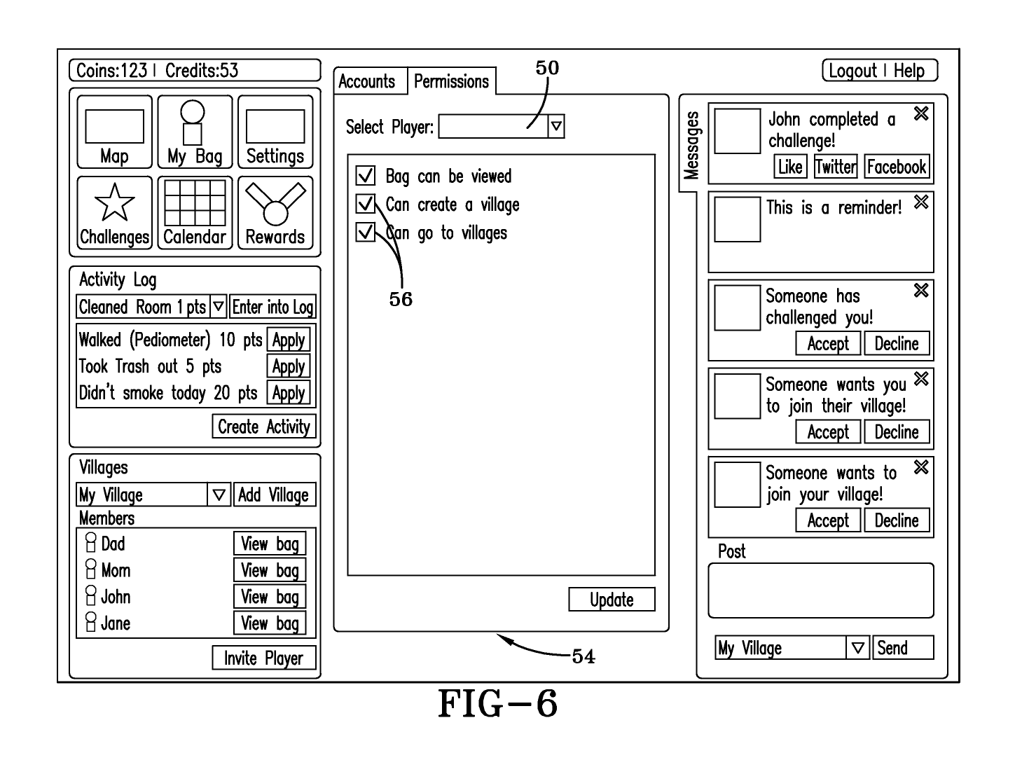

Referring to FIG. 6, a sample permissions page according to an exemplary embodiment is shown. The permissions tab 54 in the center of the page allows a user, as the account holder, to control the ability of users on its account to create villages, go to villages, or have their personal profile and information in their bag to be viewed. The user can select the player they wish to view permissions for through the use of a scroll down menu 50. Check boxes 56 allow the user to select or deselect the permissions options associated with that player. In other embodiments different types of options may be available on the permissions tab 54 to control security of the user's account. For example, the user may be able to restrict the ability of children or other users on their account to post messages, or receive messages without prior approval. The user may also be able to restrict those activities that children or other users on their account can participate in.

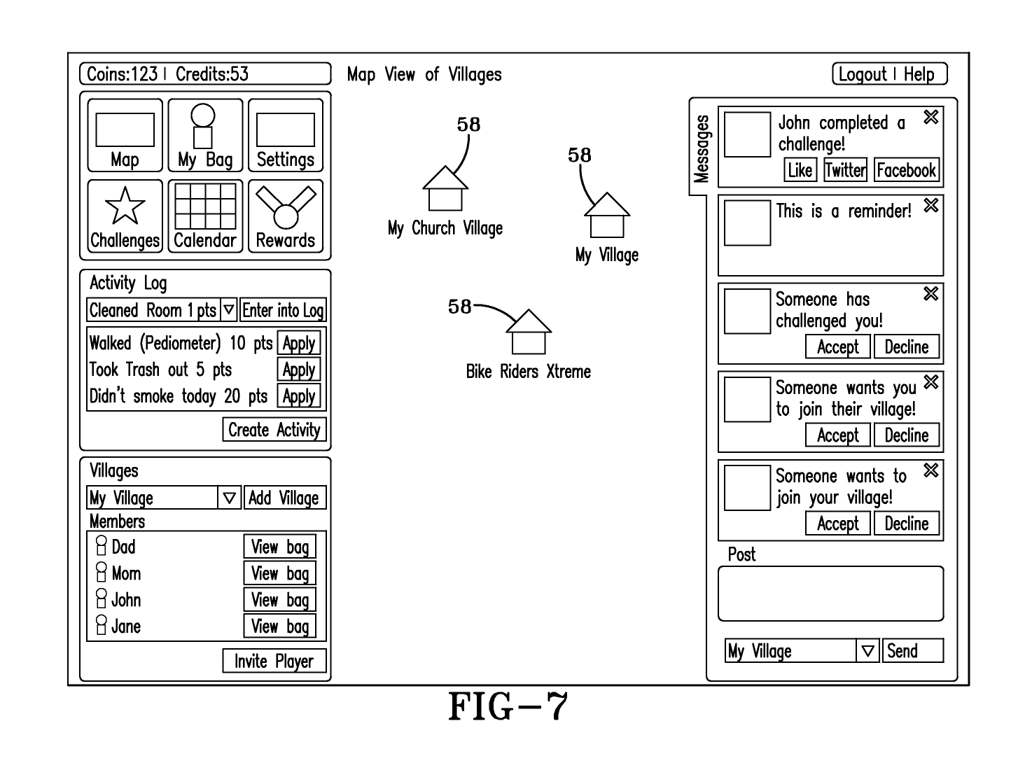

Referring to FIG. 7, a sample village map page according to an example embodiment is shown. This page may be viewed when the user selects the map button on the main control panel. Because users may be members of multiple villages, it can be helpful to users to see the villages in a map view. In the embodiment shown in FIG. 7, three different villages 58 are represented by icons. A user can select the different villages 58 to be routed to pages associated with each village 58. While the villages 58 may be shown by icons in this embodiment, in other embodiments villages 58 may be represented by photographs or other visual images. Village map pages may also give the user the opportunity to add a new village.

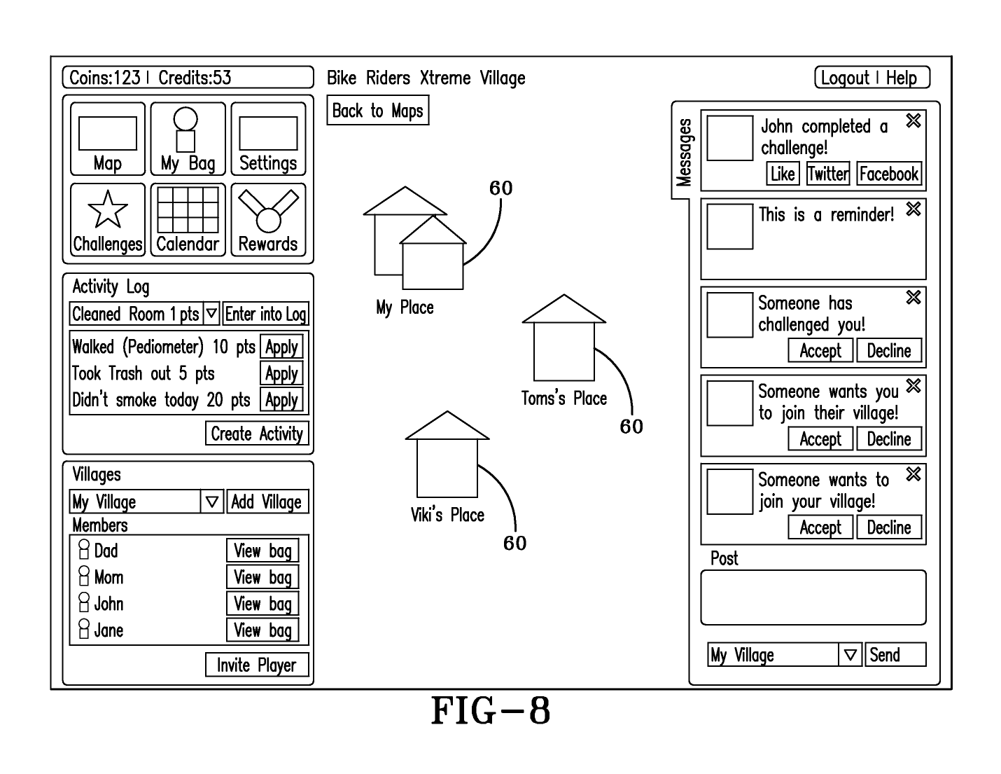

When a user clicks on a village 58 such as those shown in the embodiment of FIG. 6, different attributes about the particular village may be shown on the village's particular page. Referring to FIG. 8, a sample village page for a “Bike Riders Xtreme” village such as that shown in FIG. 6 is presented. In this embodiment information relevant to the Bike Riders Xtreme village is shown, particularly places for the members to meet up, which are represented by house icons 60 titled “My Place”, “Tom's Place” and “Viki's Place”. A user can click on a house icon 60 to find out more information about the location. In different embodiments different information related to the village and its members may be provided to the user. In some embodiments, media such as photographs, music, and videos may be associated with a village page. In other embodiments village pages may have open chat forums or other means for allowing village members to communicate with one another.

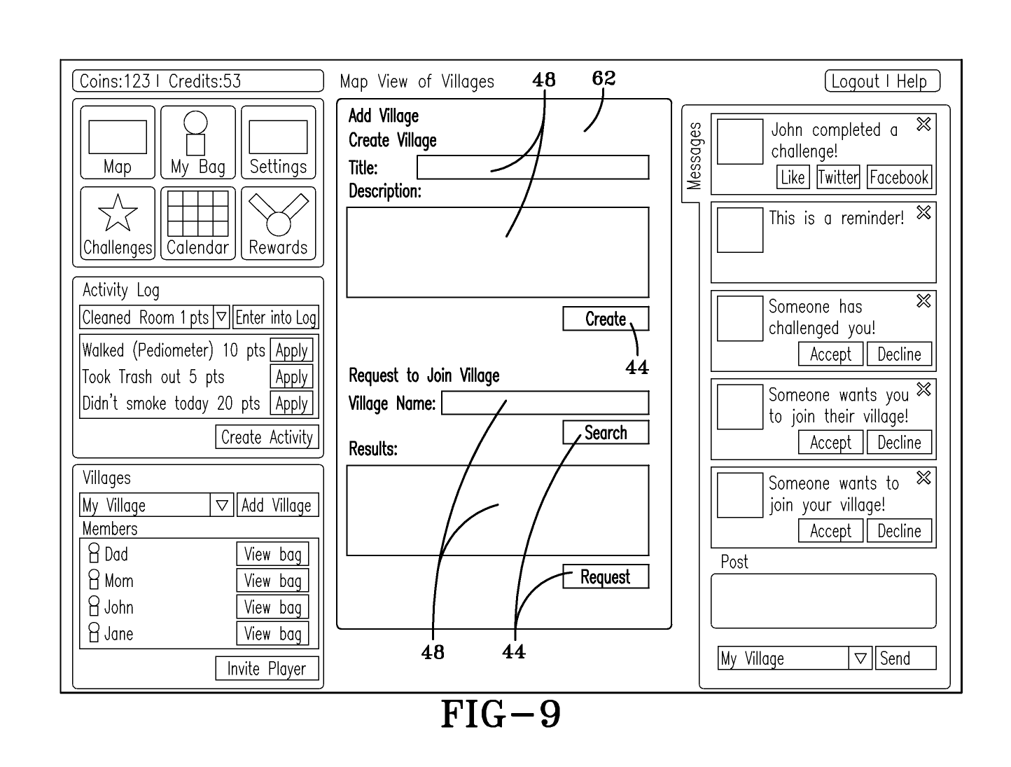

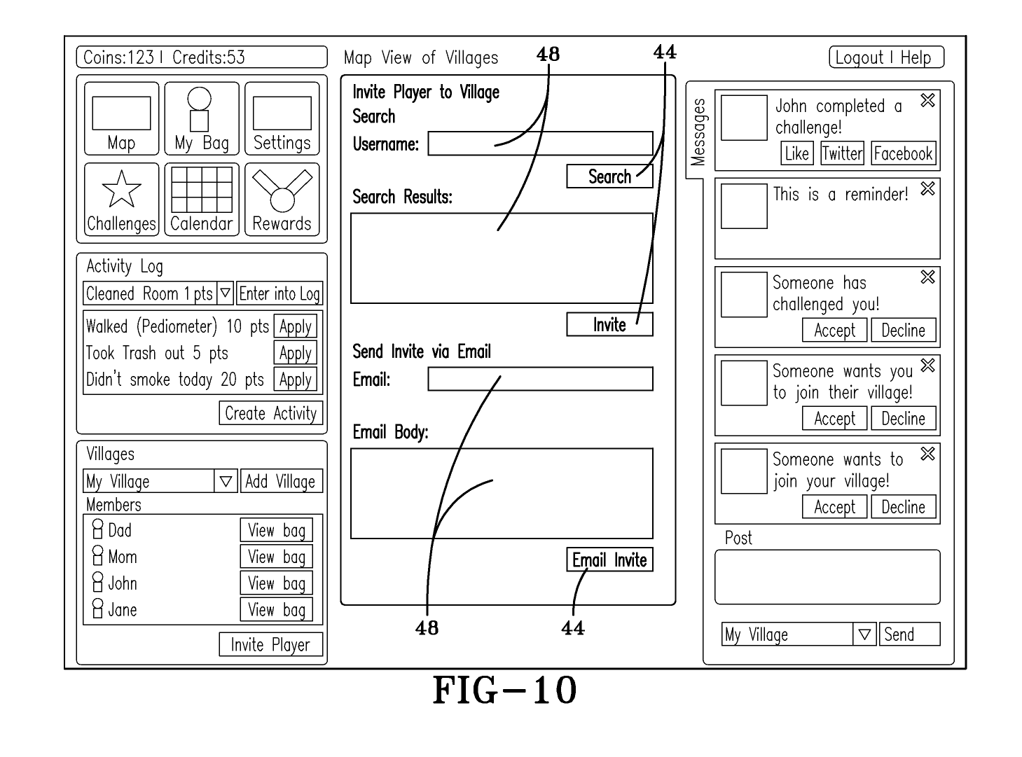

Referring to FIG. 9, a sample add village page according to an example embodiment is shown. On this page an add village panel 62 is highlighted in the foreground and the other panels on the page have been shaded. This type of visual effect may be used any time a user selects a particular option in the game in order to provide visual focus on what the user is doing. The add village panel 62 gives the user the ability to both create a village and join an existing village. For creating a village, the user can enter the title of the village in a text box 48 and enter a description of their village into a text box 48. Once completed the user can select a button 44 that creates their village. If the user desires to join an existing village, they can perform a search by entering the village name they are looking for into a text box 48 and hitting a search button 44. The villages found by the game system in its search are shown in the box below, and the user can request to join a village by hitting a request button 44. In different embodiments the user may be able to do advanced searches in which villages can be found not only by name, but by subject matter, geographic area, or other characteristics.

Referring to FIG. 10, a sample invite page according to an example embodiment is shown. An invite panel 64 is highlighted, while the rest of the page is shaded. The user can type another user's username into a text box 48 to find that person, and then can invite them to join their village. If a user prefers to invite someone through e-mail, the user can enter their email address into a text box 48 and write them an email in another text box 48 before hitting an email invite button 44. In other embodiments users may be able to invite other users to a particular village through another social networking site or other means.

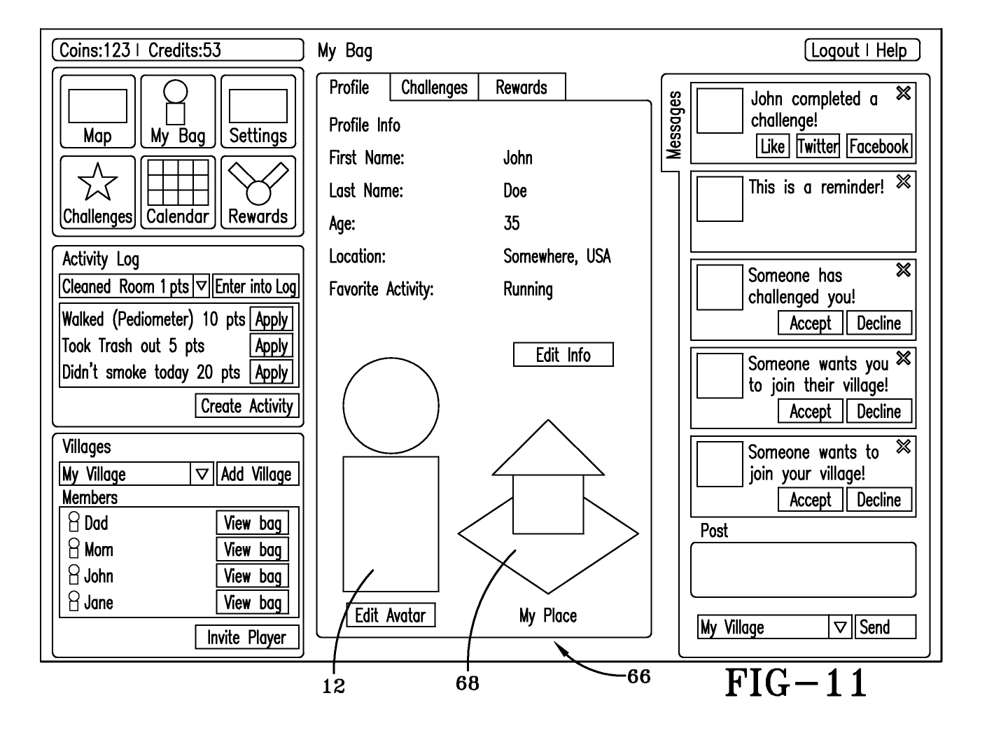

Referring to FIG. 11, a sample profile page according to an example embodiment is shown. In this figure a profile tab 66 has been selected by the user, and it displays profile information about the user including the name of the user, the user's age, location, and the user's favorite activity. The profile tab 66 may be activated by selecting one of the buttons on the main control panel 32. The profile tab 66 also includes a button 44 that the user can select to edit their profile information. The profile tab 66 includes an image of the user's avatar 12, and a button 44 that allows the user to edit their avatar. The profile tab 66 also includes an image of the user's location, titled “My Place” 68. In different embodiments different information regarding the user and their avatar 12 may be shown by the profile tab 66 and allowed to be edited through the profile tab 66.

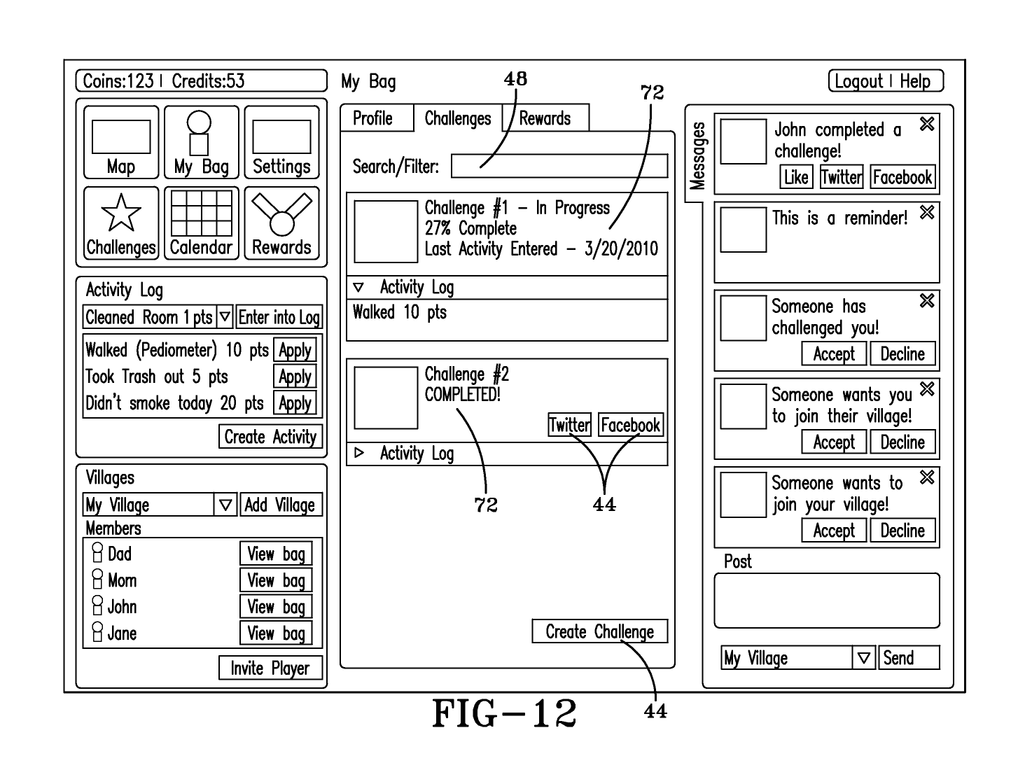

Referring to FIG. 12, a sample challenges page according to an example embodiment is shown. A challenges tab 70 contains challenge messages 72 that allow the user to keep track of challenges that they are participating in. The user can track their progress in a particular challenge, can review an activity log associated with a particular challenge, and can review completed challenges. Buttons 44 on the challenges tab 70 allow the user to post information about challenges on other social networking sites. A button 44 also allows the user to create a new challenge. A text box 48 on the challenges tab 70 also allows the user to search for a particular challenge.

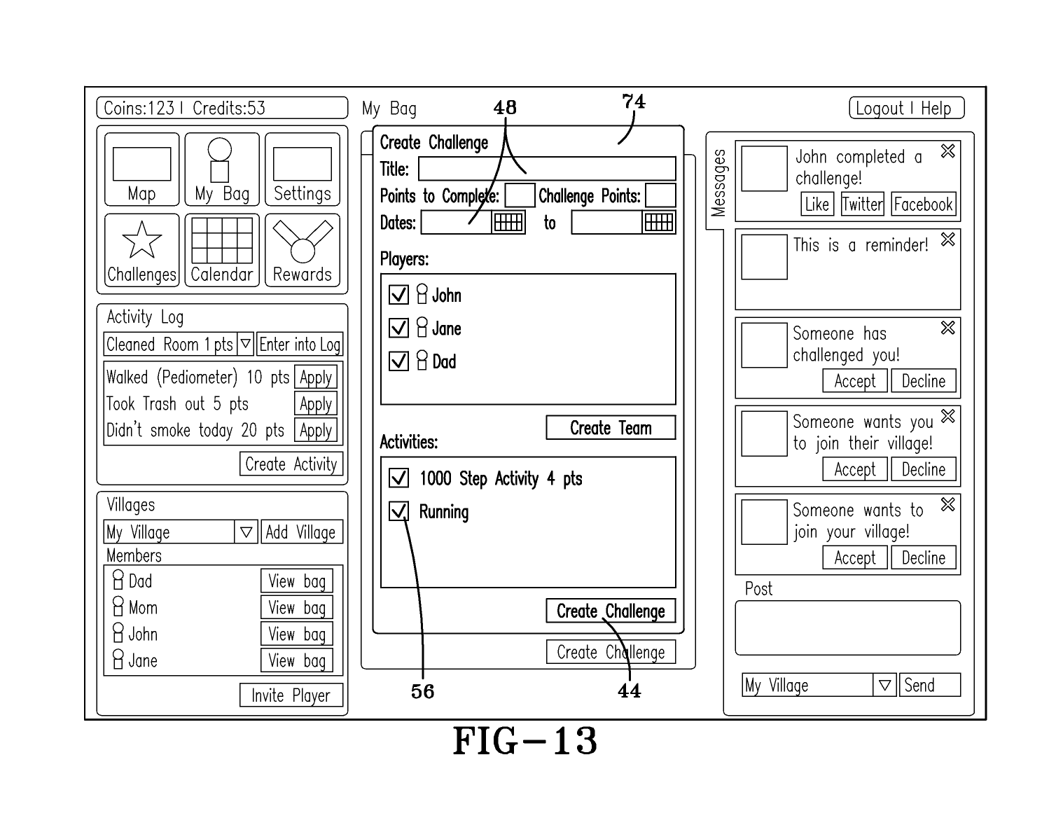

Referring to FIG. 13, a sample create challenge page according to an example embodiment is shown. The create challenge page has a create challenge tab 74 with text boxes 48 that allow the user to fill in the title of their challenge, points information associated with their challenge, and the dates associated with the challenge. Check boxes 56 allow the user to select and deselect other players to include on a team. Once players are selected, buttons 44 can be used to create the team. The user determines the activities to include in the challenge by selecting text boxes corresponding to the desired activities. When the user has selected the players for the team and the activities, it can then select a button that will create the challenge.

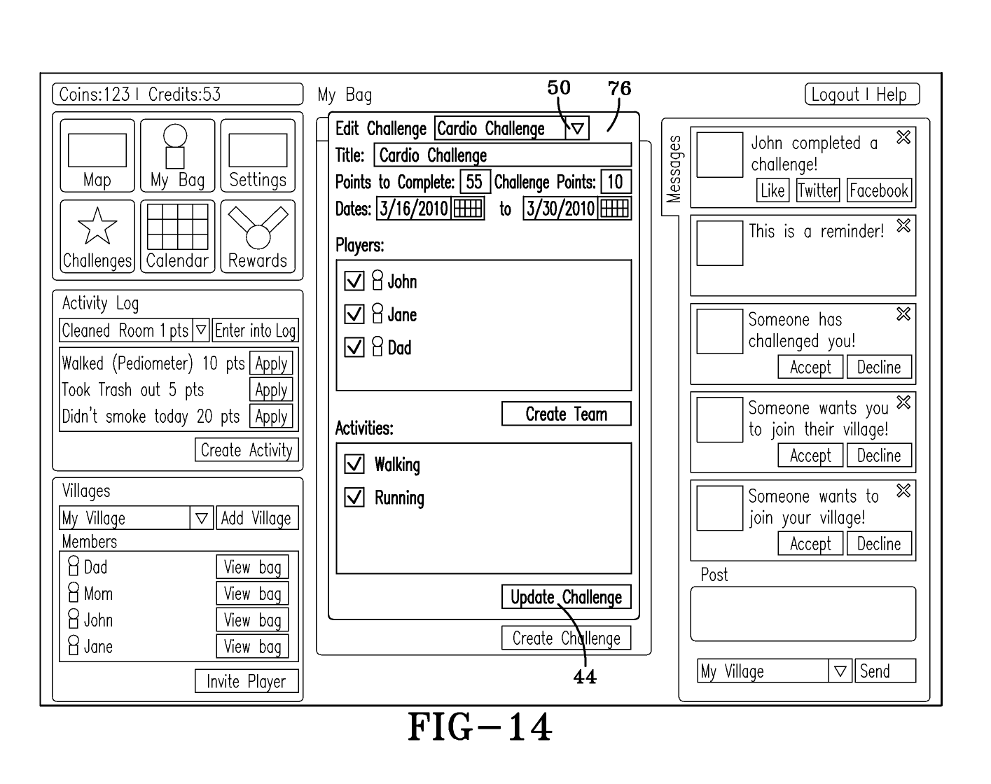

Once a challenge has been created, a user may desire to edit the challenge. Referring to FIG. 14, a sample edit challenge page according to an example embodiment is shown. On the edit challenge panel 76 the user can select the challenge to edit from a scroll down menu 50, and can edit information regarding points, dates, players involved, and the activities. Once the user is satisfied with the edits made to the challenge they can select a button that 44 that will update the challenge.

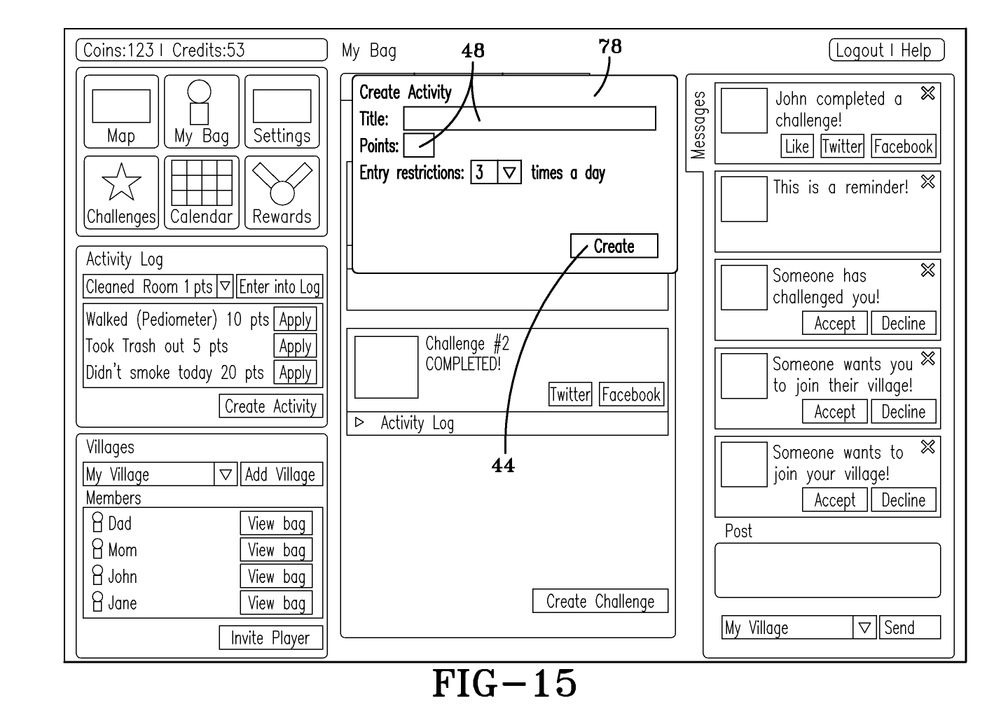

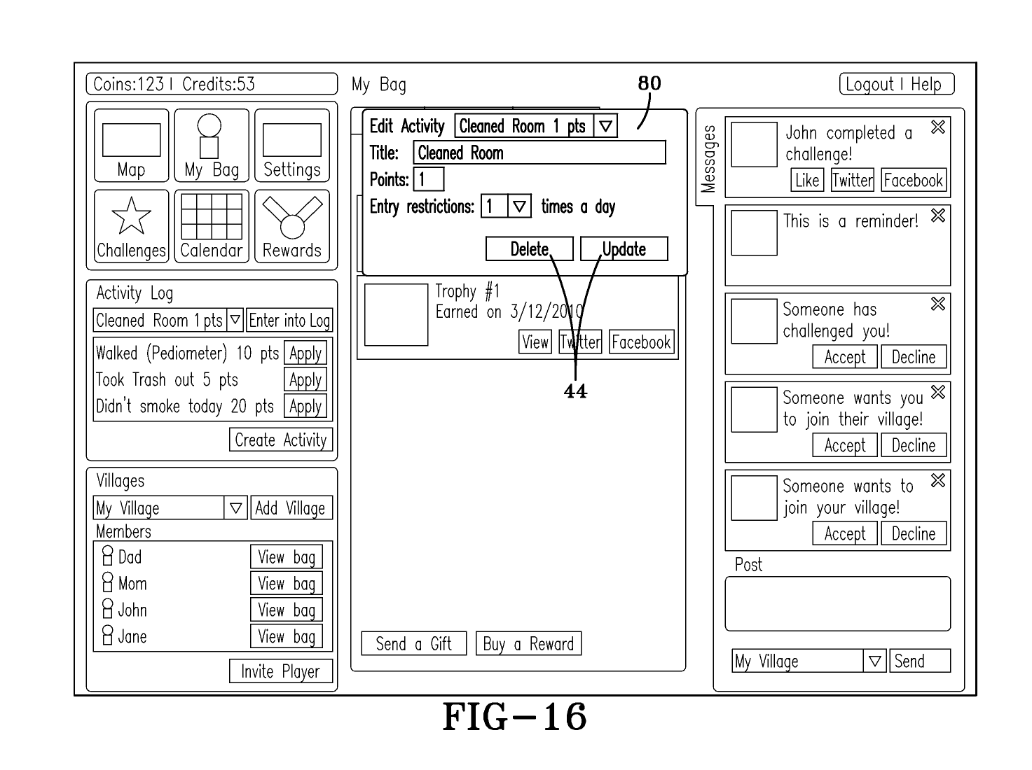

Sometimes the user may wish to create an activity that is not already available in the game. Referring to FIG. 15, a sample create activity page according to an example embodiment is shown. A create activity panel 78 has been highlighted while the rest of the page is shaded. Text boxes 48 on the create activity panel 78 allow the user to give a title to the activity, enter how many points are attributable to the activity, and determine any restrictions on the activity. For example, in the embodiment shown in FIG. 15, the user has selected to restrict the activity to three times a day. In different embodiments different information regarding activities may be set by the user. Once the user has finished determining the characteristics of the activity, they can select the create button 44 that will then make that activity available in the associated challenge. Once the activity is created, a user may desire to edit the activity's characteristics.

Referring to FIG. 16, a sample edit activity page according to an example embodiment is shown. An edit activity panel 80 is highlighted while the rest of the page is shaded. The edit activity panel 80 allows the user to edit information regarding the activities title, points associated with the activity, and any restrictions associated with the activity. The user can select available buttons 44 on the edit activity panel 80 to delete the activity entirely, or update the activity according to the user's edits. In those embodiments where additional information regarding an activity is in the system, the user may have the ability to edit that information as well.

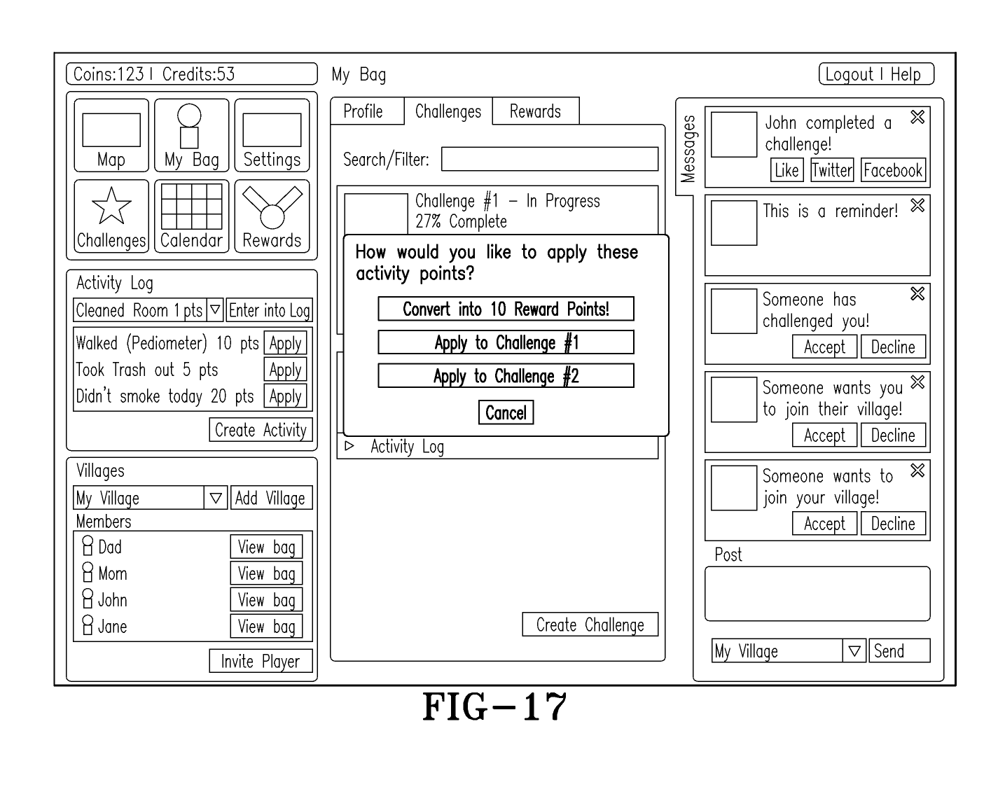

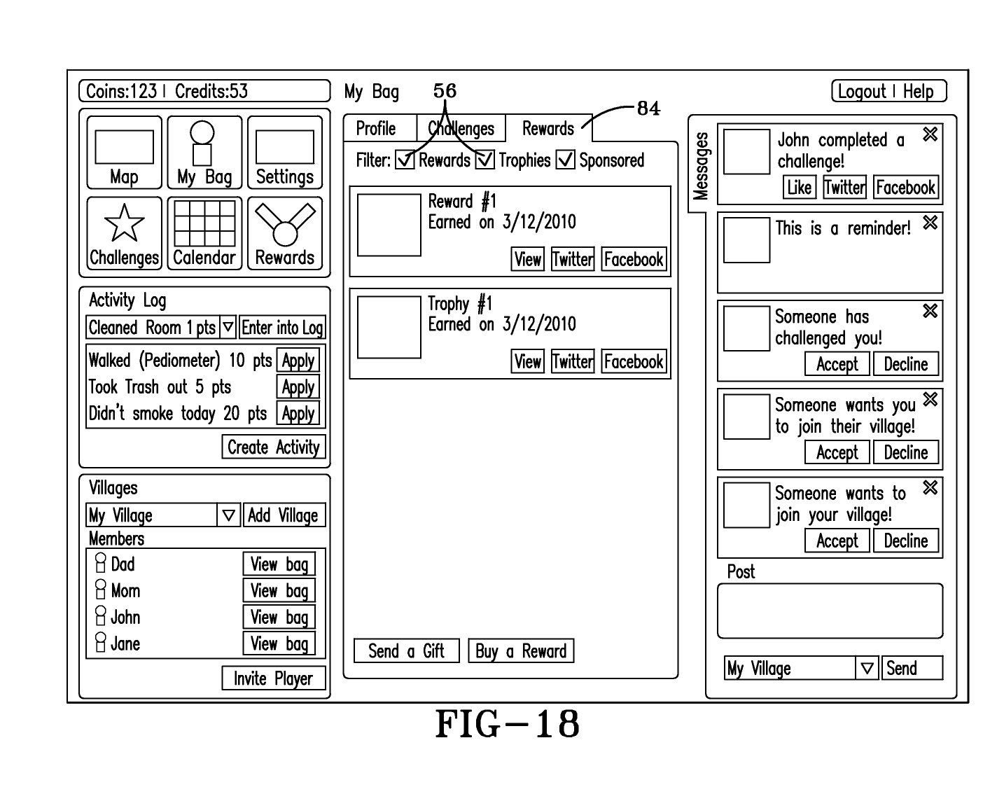

When a user has completed an activity there may be several ways in which the points associated with that activity can be utilized. Referring to FIG. 17, a sample points application page according to an example embodiment is shown. A points application panel 82 has been highlighted while the rest of the page is shaded. The points application panel 82 allows the user to determine what they wish to do with points earned from an activity. In this embodiment the user has the option of converting their activity points into reward points, or applying the activity points to different challenges that the user is involved with.

Referring to FIG. 18, a sample rewards page according to an example embodiment is shown. A rewards tab 84 displays information about rewards and trophies received to the user. Check boxes 56 on the rewards tab 84 allow the user to filter information shown on this page. For example, the user could filter information so that it only receives information regarding rewards. Or, the user could filter information so that it only receives information regarding sponsored rewards. Buttons 44 on this page also allow the user to view further information about trophies and rewards, or post information about trophies and rewards on other social networking sites. Buttons 44 located at the bottom of the page allow the user to send gifts to other players, or buy rewards using points.

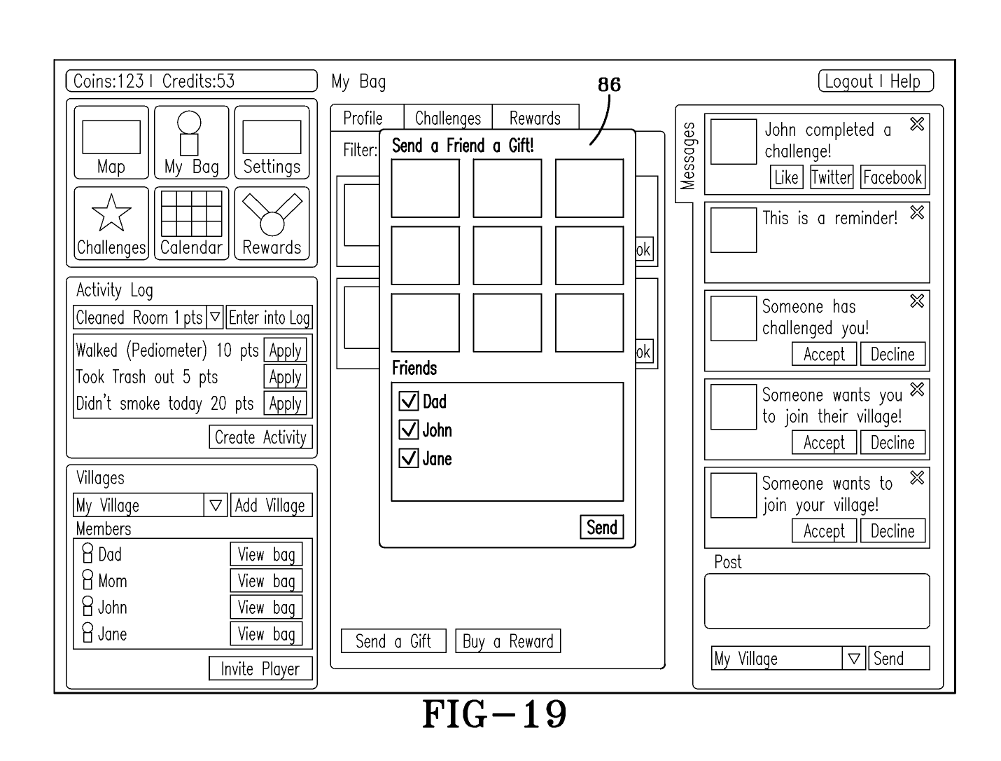

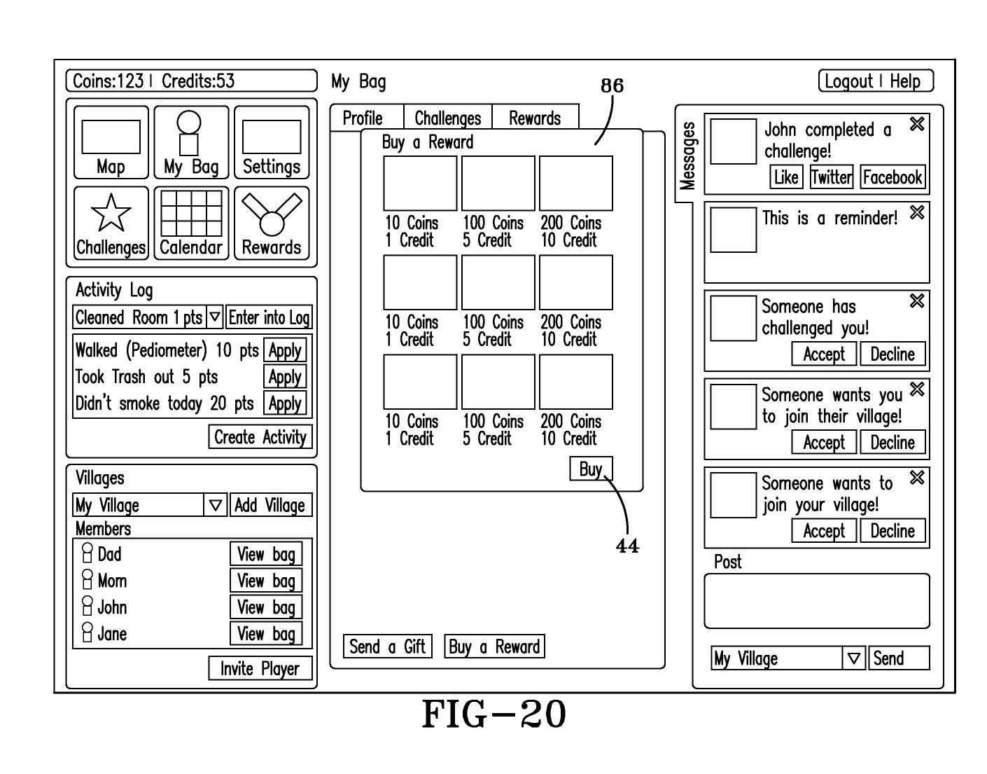

Referring to FIG. 19, a sample gift page of an example embodiment is shown. A gift panel 86 is shown highlighted while the rest of the page is shaded. Different gifts may be selected from the gift panel 86 and sent to selected users. In some embodiments pictures of the gifts may be shown on this page to aid the user in determining which gifts to send. Point values associated with the gifts may also be shown on this page to aid the user in their decision.

Referring to FIG. 20, a sample buy rewards page according to an example embodiment is shown. A buy rewards panel 88 is highlighted while the rest of the page is shaded. The buy rewards panel 88 provides information to the user about the different rewards that may be purchased, including the coins and costs to the user. The user can select the rewards they are interested in to learn more about the rewards. A button 44 allows the user to buy those rewards that it has selected. In some embodiments pictures of the rewards are provided to aid the user, and the user can select an image of a reward to learn more information about that reward.

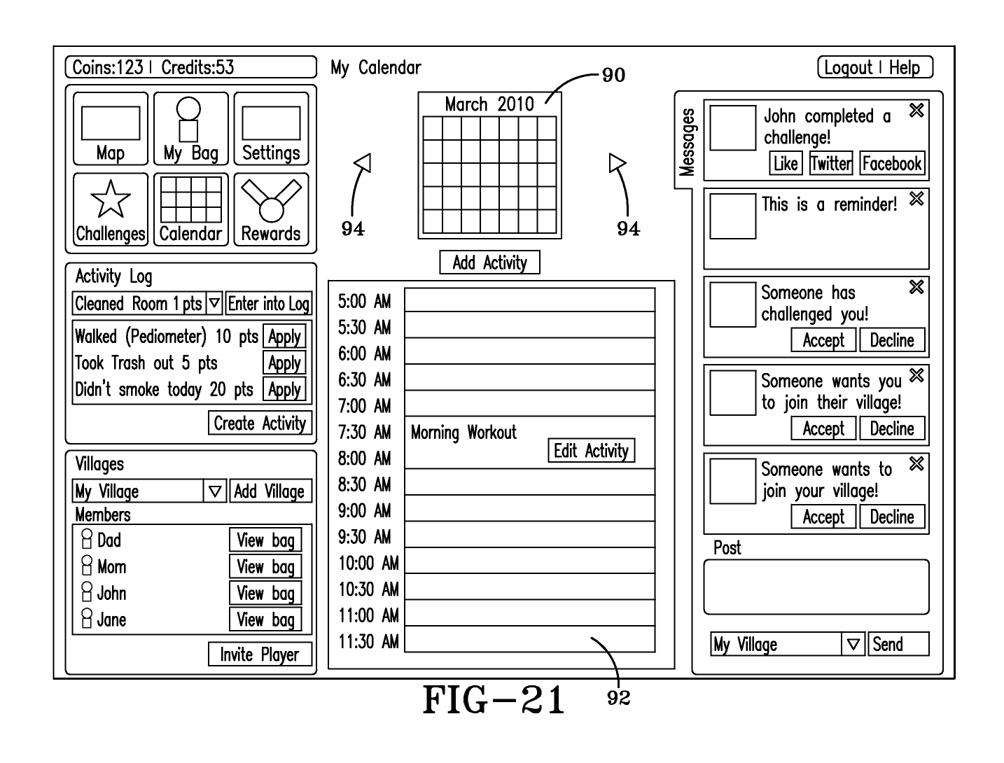

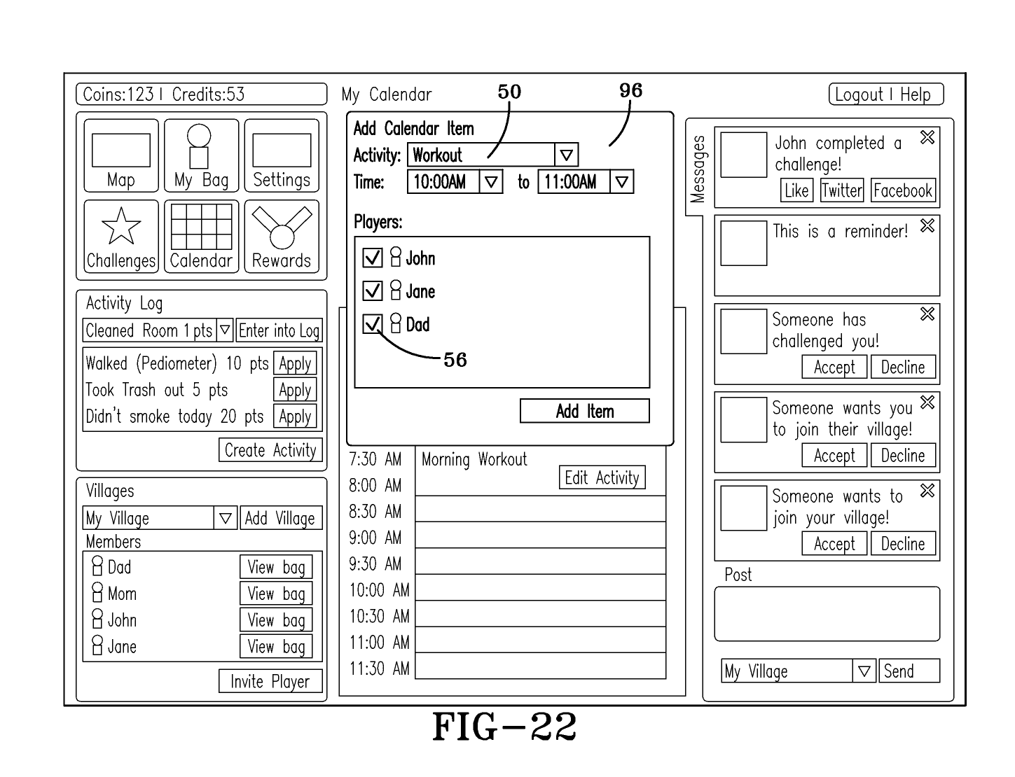

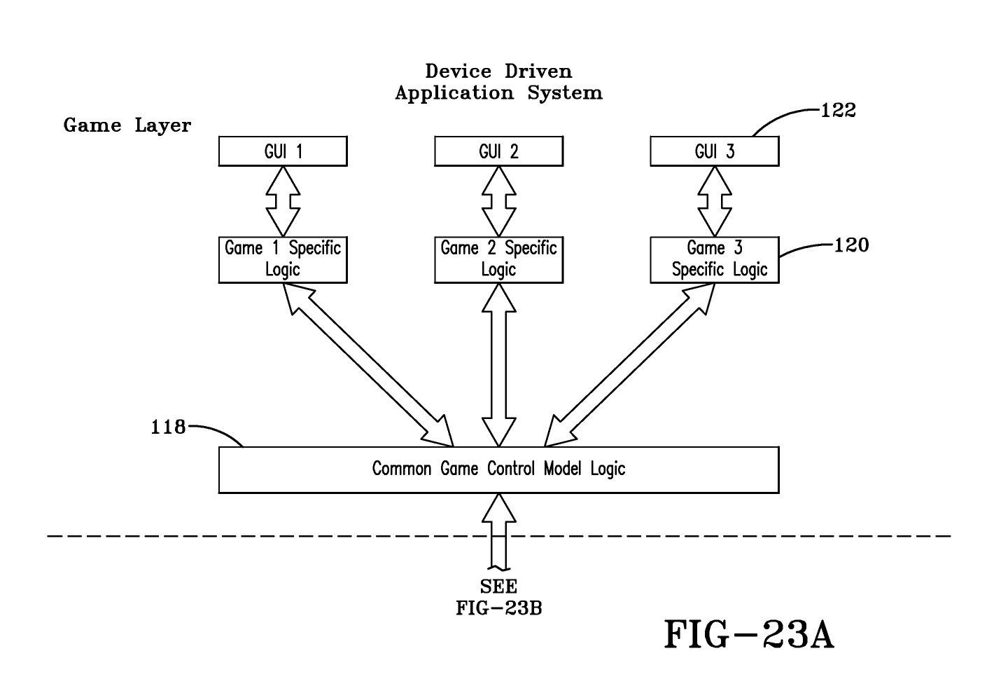

Referring to FIG. 21, a sample calendar page according to an example embodiment is shown. This page may be accessed by selecting the calendar icon in the main control panel 32. On the calendar page the user's monthly calendar 90 is shown, along with a daily calendar 92. The daily calendar 92 is accessed by selecting the desired day from the monthly calendar 90. Arrows 94 on either side of the monthly calendar allow the user to go back and forth between different months. As shown in FIG. 21, the daily calendar 92 may show scheduled activities for the user. In FIG. 21 a morning workout has been scheduled on the day shown. Buttons 44 allow the user to add activities to the daily calendar 92 and edit existing activities. In different embodiments different ways of displaying the user's calendar and scheduled activities may be used. Referring to FIG. 22, a sample add calendar item page according to an example embodiment is shown. Through scroll down menus 50 on the add calendar item panel 96 the user is able to the activity desired and the time during which it will occur. The user can also select check boxes 56 to designate the other users that this activity applies to. In this figure the players selected are John, Jane, and Dad. Once this item is added by selecting the add item button, this activity may be seen on the calendars for John, Jane and Dad.

Devices that may be associated with the game system include pedometers, which measure the number of steps a user takes throughout the day. Pedometers are commonly available in the market, and are made by many manufacturers including Sportline®, Gaiam®, SportBrain® and FitLinxx®. Pedometers are typically carried by a person on their belt, waistband, or shoe for optimum accuracy. Vendors such as SportBrain® and FitLinxx® offer pedometers that support data uploads to a computer and storage by the vendor in a data file corresponding to the user and available to the user online. Data from a pedometer may either be directly uploaded to a computer via a USB connection, or may be uploaded automatically through a wireless connection made between the pedometer and a remote access point that is connected to the computer via a USB port.

In different embodiments the game system may offer different applications to its user. In some embodiments users may be able to log into the game and then have access to other games that will draw upon information provided by the user. For example, the user may be able to access a virtual fish tank where the user is represented by a fish avatar and the location of the fish avatar is a result of the activity level of the user. In some embodiments the game may be able to link directly to applications and websites on the internet such as another social networking site so that a user can visit their site's page or other on-line location directly from the game without having to log out of the game. In some embodiments the game system may pull news articles or other information from the internet that matches the user's profiled interests. In these embodiments the game system provides the user with tailored news information when the user logs in. In different embodiments user avatars have different looks and different abilities. In some embodiments the avatars may be animals or may be icons representing a user's favorite sport or hobby (e.g., a football). In some embodiments if a user selects their avatar and moves it next to another user's avatar, an on-line chat session begins automatically.

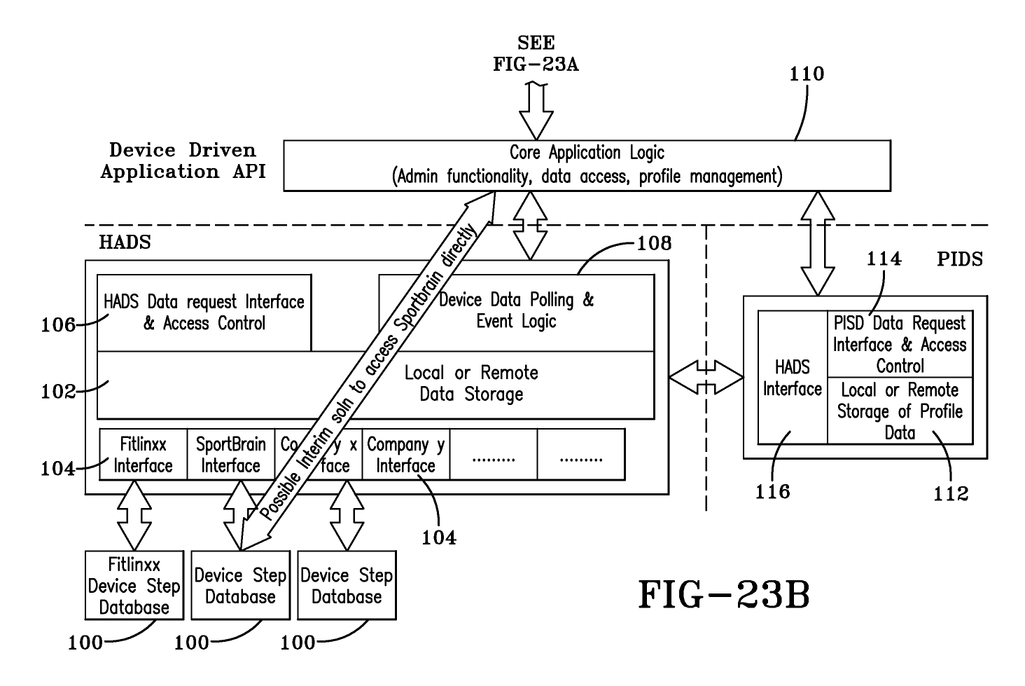

Referring to FIG. 23, a logic diagram of the system of an example embodiment is shown. In this embodiment, different device databases 100 contain data obtained by devices such as pedometers. Data that may be contained in a pedometer device database includes the amount of steps taken in a particular amount of time. Device databases 100 may be associated with biometric devices other than pedometers, or any other device that can be used to obtain activity data. Data is sent from the device databases 200 to a local or remote device data storage 102 via a device interface 104. The device data storage 102 is able to receive data from multiple devices through device interfaces 104 that may each be tailored to a specific device database 100 or a particular type of device databases 100. The device data storage 102 is associated with a data request interface 106 and device data polling and event logic 108. The data request interface 106 receives requests for data from a core application 110. Through the data request interface 106, the core application 110 is able to request data from any device that is associated with the data storage 102. The data requested is uploaded to the core application 110 using device data polling and event logic 108.

The system also includes local or remote profile data storage 112. The profile data comprises data for different users of the game system, and may include their names, avatar information, and permissions information. Profile information may be communicated back and forth between the core application 110 and the profile data storage 112 through a profile data request interface 114. The profile data request interface may also control access to the profiles, and verify that the profile information sought is permitted to be provided based on the circumstances of a particular request. Information may be transferred between the profile data storage 112 and the device data storage 102 via a device/profile interface 116. By being connected to the device data and profile data, the core application 110 provides administrative functionality in the game system. The core application 110 may oversee the registering of devices so that it can seek device data that corresponds with a particular user. The core 110 application may control data access of both device and profile data. The core 110 application may also manage the different user profiles, so that game users can enjoy a personalized game experience. In some embodiments the core application 110 can communicate directly with the device databases 100 to receive device data. In other embodiments the core application 110 may have additional functions and abilities. The core application 110 communicates with a common game control module 118 that executes the logic necessary for the common user game experience. The module includes logic pertaining to those elements of the game that overlap for different users. The common game control 118 dictates the game specific logic 120 of each game being played by a user through the game user interface 122. As shown in FIG. 23, the common game control 218 is able to control the logic in multiple games as they are being played. Actions of the players as received by the game user interface 122 affects the game specific logic 120 which in turn impacts the logic of the common game control 118. It is in this way that the actions of a single user can impact the game experience of other users.

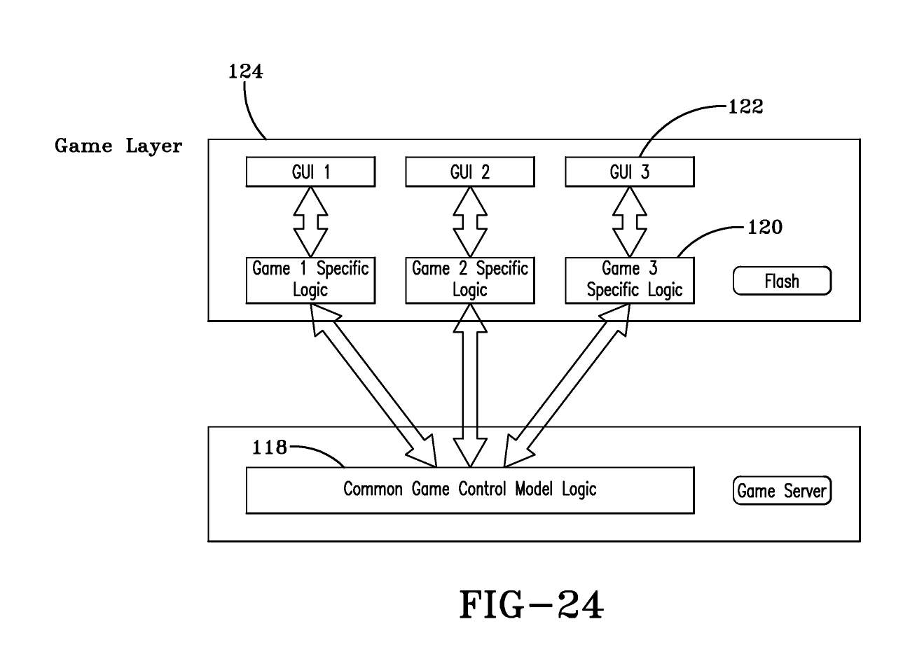

Referring to FIG. 24, a system diagram of an example embodiment is shown. The game layer 124 is comprised of the game user interface 122 and the game specific logic 120. The animation and interactivity of the game layer may be developed using a Flash by Adobe® platform or any other type of multimedia platform. As shown in FIG. 24, in some embodiments the common game control model logic 118 may be performed by a server.

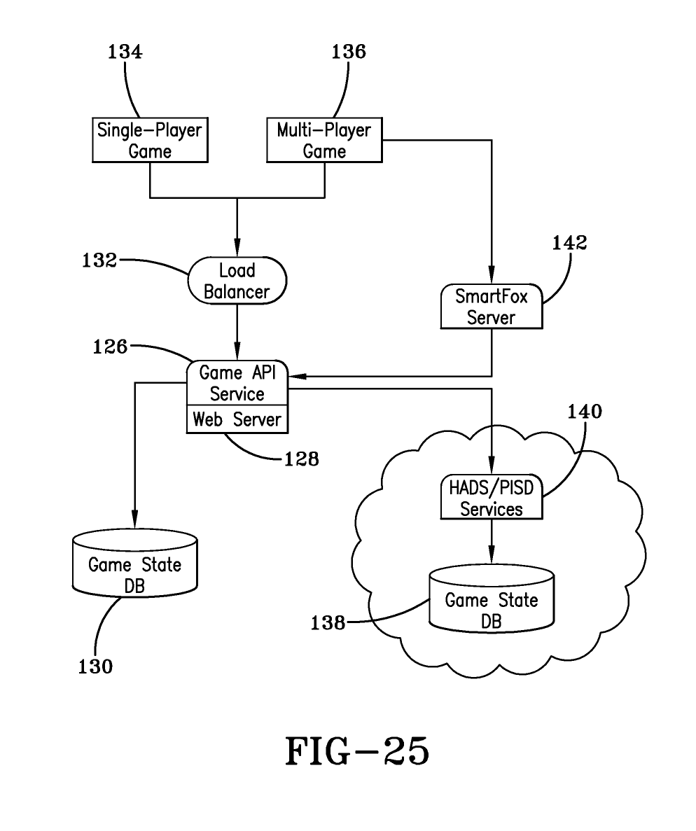

Referring to FIG. 25, a system diagram of an example embodiment is shown. In this embodiment, a game application programming interface (“API”) service 126 associated with a web server 128. The game API service 126 is connected to a game state database 130 that contains data received from different user devices. The game API service 126 transmits game information to a load balancer 132, which balances the loads between different single-player games 134 and multi-player games 136. The game API service 126 may receive device data from a remote game state database 138 associated with profile and device services 140. The profile and device services 140 provides data to the game API Service regarding the different user devices and user profiles. The profile and device services 140 also control access to device and profile data. As shown in FIG. 25, in some embodiments of the present invention a multiplayer platform 142 such as one provided by SmartFoxServer™ may act as an intermediary between multi-player games 136 and the game API Service 126. The multiplayer platform 142 provides web-based multi-user applications and allows multiplayer interactions. It may also provide the applications necessary for users to access the game from their cell phones and other personal electronic devices. The multiplayer platform 142 utilizes the logic established by the game API Service 142.

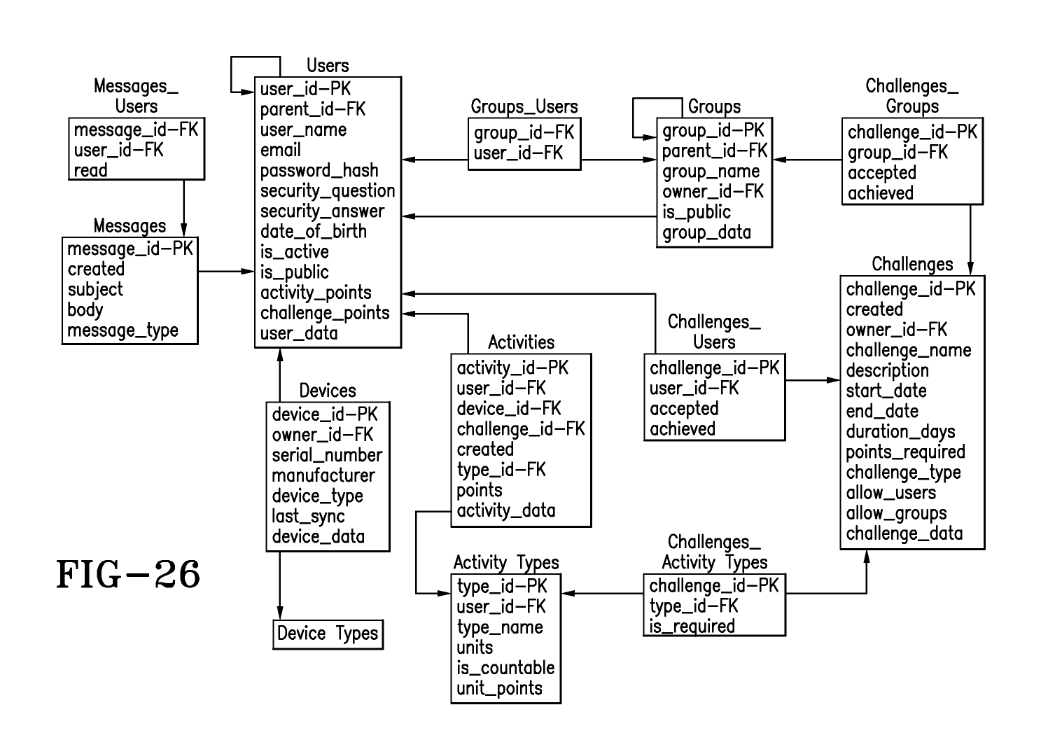

FIGS. 23, 24, and 25 represent a embodiments of the game system. In different embodiments the game system may have different architecture and components. FIG. 26 is an entity relationship diagram for an example embodiment.

Appendix A provides details the different fields used in an exemplary embodiment of the present invention. In this example, a flow chart shows the flow of data and information throughout the game system, and a description of the different data fields is given.

While certain embodiments of the present invention are described in detail above, the scope of the invention is not to be considered limited by such disclosure, and modifications are possible without departing from the spirit of the invention as evidenced by the claims:

1-7. (canceled)

8. A computerized system for promoting participation in health activities, comprising:
(a) a database storing:
(1) for each of a plurality of user-defined challenges challenge data comprising:
(i) a challenge identifier; and
(ii) activity data comprising for each of a plurality of activities corresponding to said user-defined challenge:
an activity identifier; and
an activity point value;
(2) for each of a plurality of users agreeing to participate in at least one of said user-defined challenges account data comprising:
(i) a user identifier;
(ii) one of said plurality of challenge identifiers selected by said users; and
(iii) a challenge point total;
(b) a server with programming instructions to:
(1) receive at said server from each of said plurality of users a plurality of said activity identifiers for activities corresponding to said challenge identifier said activity identifiers from biometric devices for said plurality of users;
(2) update at said server said challenge point total in said account for each of said plurality of users by adding to said challenge point total said activity point values corresponding to said activity identifiers received from said user;
(3) receive at said server from each of said plurality of users GPS data corresponding to a village location identifier for a location in a virtual village; and
(4) receive at said server from one of said plurality of users a location view request for said village location identifier; and
(5) in response to said location view request, generate at said server for said user a display comprising:
(i) a background for said village location identifier;
(ii) an avatar for each of said plurality of users at said village location identifier;
(iii) said challenge identifier; and
(iv) an indicator of said challenge point total for each of said plurality of users for said challenge identifier; and
(v) an indication of said user's progress toward said challenge point value for said challenge identifier;
(6) receive at said server said challenge identifier;
(7) receive at said server a new activity identifier; and
(8) update at said server said challenge point total for said challenge identifier by adding an activity point value for said new activity identifier.

9. The system of claim 8 wherein said server receives said activity identifiers in self-reported activity data from said plurality of users.

10. (canceled)

11. The system of claim 8 wherein said server further comprises programming instructions to:
(6) compare for each of said plurality of users said challenge point total for said challenge identifier;
(7) identify at said server a user with a highest challenge point total; and
(8) generate at said server for each of said plurality of users a display identifying said user as a winner of a contest associated with said challenge identifier.

12. The system of claim 8 wherein said activity data further comprises an award identifier.

13. The system of claim 12 wherein said server further comprises programming instructions to update at said server said account for each of said plurality of users with said award identifier for each of said plurality of activity identifiers received from said user.

14-20. (canceled)
